(19) United States
(12) Patent Application Publication
(10) Pub. No.: US 2026/0287320 A1
(43) Pub. Date: Sep. 24, 2026

(54) IN-LINE DETECTOR FOR GEOMETRIC DEFORMATION OF NON-METALLIC PIPELINE WITH AUTOMATIC JAM RELEASE FUNCTION

(71) Applicant: CHANGZHOU UNIVERSITY, Changzhou (CN)

(72) Inventors: Ying ZHANG, Changzhou (CN); Haoye LIN, Changzhou (CN); Xueqin WANG, Changzhou (CN); Yirong WU, Changzhou (CN); Haonan FENG, Changzhou (CN); Yu’ang CHEN, Changzhou (CN); Xin LI, Changzhou (CN); Zhengquan LIU, Changzhou (CN)

(73) Assignee: CHANGZHOU UNIVERSITY, Changzhou (CN)

(21) Appl. No.: 19/449,445

(22) Filed: Jan. 15, 2026

(30) Foreign Application Priority Data
Mar. 21, 2025 (CN) 202510338345.6

(51) Int. Cl. G01B 5/30; F16L 55/40; F16L 101/30

(52) U.S. Cl. CPC G01B 5/30; F16L 55/40; F16L 2101/30

(57) ABSTRACT

Provided is an in-line detector for geometric deformation of a non-metallic pipeline with automatic jam release function. The in-line detector includes an adaptive module; the adaptive module includes a front mandrel; a first cup is configured to contact and seal an inner peripheral wall of the pipeline to form a first chamber and a second chamber which are separated from each other in a front-and-back direction of the first cup; an auxiliary support mechanism; the in-line detector further includes a detection module; the detection module includes a base; a power battery, a communication mechanism connected to an external device, and a second cup are disposed on the base; the connecting hole is disposed at an end of the base close to the front mandrel; an end of the front mandrel matches the connecting hole; and a restoring mechanism is disposed between the end of the front mandrel and the base.

### CROSS-REFERENCE TO RELATED APPLICATIONS

This application claims priority to the Chinese Patent Application No. 202510338345.6, filed on Mar. 21, 2025, the contents of which are hereby incorporated by reference.

### TECHNICAL FIELD

The present disclosure relates to the field of in-line detectors for geometric deformation of pipelines, particularly to an in-line detector for geometric deformation of a non-metallic pipeline with an automatic jam release function.

### BACKGROUND

Non-metallic pipelines are widely used in the field of oil and gas transportation due to their advantages such as corrosion resistance, low friction resistance, and energy savings. However, influenced by factors such as third-party damage and ground settlement, pipe joints are prone to misalignment, and pipe bodies are prone to deformation, which may lead to pipeline leakage and cause more serious fire and explosion accidents. Therefore, deformation detection for non-metallic pipelines is urgently needed.

Meanwhile, before performing pipeline corrosion detection, pipeline deformation detection must be performed first, i.e., detecting the degree and location of deformation in straight pipe sections, elbows, miter joints, and welds. Only after confirming that the pipeline has adequate passing capacity for an in-line detector can the in-line detector be deployed for corrosion detection. However, the deformation condition of the pipeline is unknown before deploying the in-line detector for geometric deformation. Once the in-line detector for geometric deformation becomes jammed in the pipeline, pipeline shutdown may occur. In severe cases, the pipeline may even need to be cut open to retrieve the in-line detector. Therefore, the in-line detector for geometric deformation requires enhanced passing capacity under working conditions prone to jamming.

Furthermore, most existing in-line detectors for geometric deformation of pipelines are designed for steel pipelines. The detection arms of the existing in-line detectors are in rigid contact with the wall surface of the pipeline, which easily scratch the pipeline wall and damage it. Meanwhile, the design of the existing in-line detectors for geometric deformation does not fully consider the passing capacity of the in-line detectors at elbows and deformed locations, resulting in these detectors still being prone to jamming during operation. Particularly in the field of deformation detection for non-metallic pipelines, relevant in-line detectors for geometric deformation are even scarcer in the market. In view of this, the present disclosure provides an in-line detector for geometric deformation of a non-metallic pipeline with an automatic jam release function.

### SUMMARY

One or more embodiments of the present disclosure provide an in-line detector for geometric deformation of non-metallic pipeline with an automatic jam release function. The in-line detector includes: an adaptive module and a detection module. The adaptive module includes a front mandrel, a first cup is disposed on the front mandrel, the first cup is configured to contact and seal an inner peripheral wall of the pipeline to form a first chamber and a second chamber which are separated from each other in a front-and-back direction of the first cup, an auxiliary support mechanism configured to always contact and seal the inner peripheral wall of the pipeline when the pipeline deforms is disposed on the first cup, a first pressure relief hole configured to communicate the first chamber and the second chamber is disposed on the front mandrel, and a control mechanism configured to control an opening degree of the pressure relief hole and implement speed control is disposed in the first pressure relief hole. The detection module includes a base, a power battery and a communication mechanism for connecting to an external device are disposed on the base, a second cup is disposed on the base, a detection mechanism is disposed between the second cup and the base, the communication mechanism is in signal connection to the detection mechanism and the control mechanism, respectively, the power battery is connected to the detection mechanism, the communication mechanism, and the control mechanism, respectively, the second cup is configured to contact the inner peripheral wall of the pipeline to form a third chamber and a fourth chamber which are separated from each other in a front-and-back direction of the second cup, the second chamber and the third chamber are located between the first chamber and the fourth chamber, the second chamber and the third chamber are in communication with each other, a second pressure relief hole configured to communicate the third chamber and the fourth chamber is disposed on the base, a connecting hole is disposed at an end of the base close to the front mandrel, the connecting hole has a frustum shape, a large end of the connecting hole is close to the front mandrel, the connecting hole is disposed along an axial direction of the pipeline, an end of the front mandrel matches the connecting hole, the end of the front mandrel is disposed in the connecting hole, a restoring mechanism is disposed between the end of the front mandrel and the base, and the restoring mechanism is configured to keep the front mandrel connected to the base and assist the end of the front mandrel in inserting into the connecting hole after the end of the front mandrel is disengaged from the connecting hole; the restoring mechanism includes a first spring, one end of the first spring is fixed on the base, another end of the first spring is fixed on the front mandrel, and the first spring is located in the connecting hole; and the control mechanism includes a cover plate and one or more stoppers, the cover plate covers an end of the first pressure relief hole located at the first chamber, one or more through holes are disposed in the cover plate, the one or more through holes are configured to communicate the first chamber and the first pressure relief hole, and a driving mechanism configured to drive the one or more stoppers to move and cause the one or more stoppers to block or open the one or more through holes is disposed on the front mandrel.

### BRIEF DESCRIPTION OF THE DRAWINGS

The present disclosure is further described in detail by way of exemplary embodiments. The exemplary embodiments are described in detail with reference to the accompanying drawings. The embodiments are not limiting. In the embodiments, the same reference numerals denote the same structures, wherein:

FIG. 1 is a first schematic diagram illustrating a three-dimensional structure of an in-line detector for geometric deformation of a non-metallic pipeline with an automatic jam release function according to some embodiments of the present disclosure;

FIG. 2 is a second schematic diagram illustrating a three-dimensional structure of an in-line detector for geometric deformation of a non-metallic pipeline with an automatic jam release function according to some embodiments of the present disclosure;

FIG. 3 is a schematic diagram illustrating a front view of an in-line detector for geometric deformation of a non-metallic pipeline with an automatic jam release function according to some embodiments of the present disclosure;

FIG. 4 is a schematic diagram illustrating a top view of an in-line detector for geometric deformation of a non-metallic pipeline with an automatic jam release function according to some embodiments of the present disclosure;

FIG. 5 is a schematic diagram illustrating a bottom view of an in-line detector for geometric deformation of a non-metallic pipeline with an automatic jam release function according to some embodiments of the present disclosure;

FIG. 6 is a schematic diagram illustrating an A-A sectional view of FIG. 4 according to some embodiments of the present disclosure; and

FIG. 7 is a schematic structural diagram illustrating a control mechanism according to some embodiments of the present disclosure;

Reference signs in the figures: 1. adaptive module; 101. front mandrel; 102. first cup; 1021. first fixed cup; 1022. first sealing cup; 103. auxiliary support mechanism; 104. first pressure relief hole; 105. control mechanism; 1051. cover plate; 1052. stopper; 1053. through hole;
2. detection module; 201. base; 202. second cup; 203. second pressure relief hole; 204. connecting hole; 205. restoring mechanism; 206. detection mechanism; 2061. detection arm; 2062. third spring;
3. anti-collision head.

### DETAILED DESCRIPTION

The present disclosure is further described in detail below in conjunction with embodiments:

The present disclosure is not limited to the following specific embodiments. Based on the content disclosed in the present disclosure, those having ordinary skills in the art may implement the present disclosure in various other specific embodiments. Alternatively, any simple modifications or changes made based on the design structure and ideas of the present disclosure fall within the protection scope of the present disclosure. It should be noted that, in the absence of conflict, the embodiments in the present disclosure and the features in the embodiments may be combined with each other.

In the description of the present disclosure, it should be understood that the orientation or positional relationships indicated by the terms “center”, “longitudinal”, “lateral”, “upper”, “lower”, “front”, “rear”, “left”, “right”, “vertical”, “horizontal”, “top”, “bottom”, “inner”, “outer”, etc., are based on the orientation or positional relationships shown in the accompanying drawings. These terms are used only for convenience in describing the present disclosure and simplifying the description, and do not indicate or imply that the referred device or element must have a specific orientation or be constructed and operated in a specific orientation. Therefore, these terms should not be construed as limiting the present disclosure. Furthermore, the terms “first”, “second”, etc., are used for descriptive purposes only and should not be construed as indicating or implying relative importance or implicitly indicating the number of the indicated technical features. Thus, features defined with “first”, “second”, etc., may explicitly or implicitly include one or more of such features. In the description of the present disclosure, unless otherwise specified, the meaning of “a plurality of” is two or more.

In the description of the present disclosure, it should be noted that, unless otherwise explicitly specified and defined, the terms “installation”, “connection”, and “linkage” should be understood broadly. For example, a connection may be a fixed connection, a detachable connection, or an integral connection. A connection may be a mechanical connection, an electrical connection, or a direct connection. A connection may be an indirect connection through an intermediate medium, or may be internal communication between two elements. For those having ordinary skills in the art, the specific meanings of the above terms in the present disclosure may be understood based on specific situations.

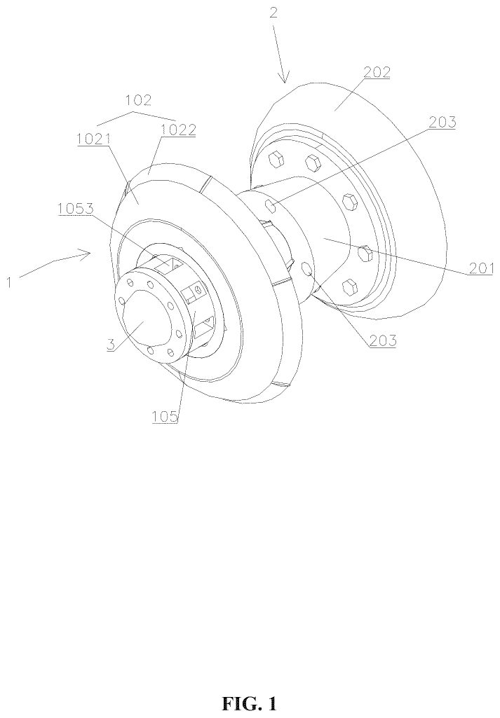

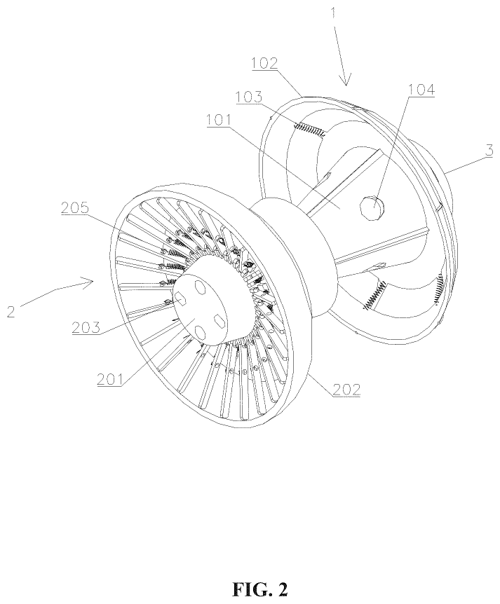

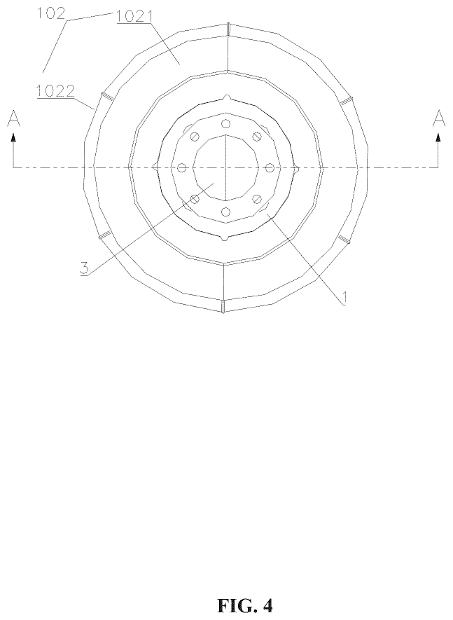

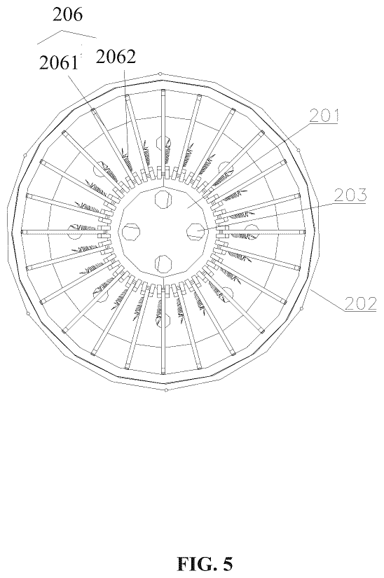

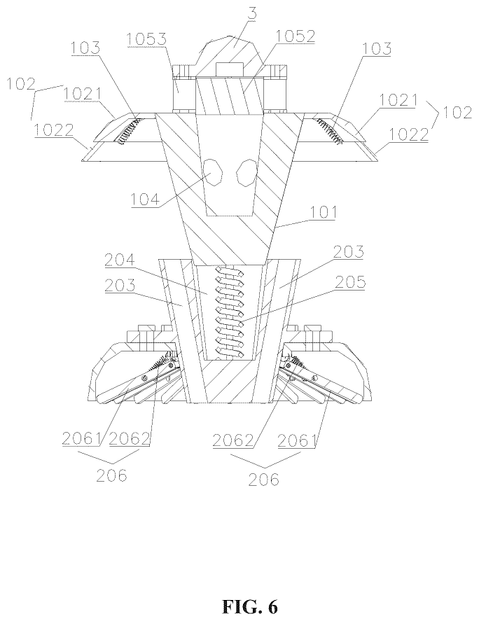

FIG. 1 is a first schematic diagram illustrating a three-dimensional structure of an in-line detector for geometric deformation of a non-metallic pipeline with an automatic jam release function according to some embodiments of the present disclosure. FIG. 2 is a second schematic diagram illustrating a three-dimensional structure of an in-line detector for geometric deformation of a non-metallic pipeline with an automatic jam release function according to some embodiments of the present disclosure. FIG. 5 is a schematic diagram illustrating a bottom view of an in-line detector for geometric deformation of a non-metallic pipeline with an automatic jam release function according to some embodiments of the present disclosure. FIG. 6 is a schematic diagram illustrating an A-A sectional view of FIG. 4 according to some embodiments of the present disclosure.

In some embodiments, as shown in FIG. 1, FIG. 2, FIG. 5, and FIG. 6, the in-line detector for geometric deformation of the non-metallic pipeline with the automatic jam release function includes an adaptive module 1. The adaptive module 1 includes a front mandrel 101. A first cup 102 is disposed on the front mandrel 101. The first cup 102 is configured to contact and seal the inner peripheral wall of the pipeline to form a first chamber and a second chamber, which are separated from each other in a front-and-back direction of the first cup 102. An auxiliary support mechanism 103, configured to always contact and seal the inner peripheral wall of the pipeline when the pipeline deforms, is disposed on the first cup 102. A first pressure relief hole 104 configured to communicate the first chamber and the second chamber, is disposed on the front mandrel 101. A control mechanism 105, configured to control the opening degree of the pressure relief hole and implement speed control, is disposed in the first pressure relief hole 104.

The in-line detector includes a detection module 2. The detection module 2 includes a base 201. A power battery and a communication mechanism for connecting to an external device are disposed on the base 201. A second cup 202 is disposed on the base 201. A detection mechanism 206 is disposed between the second cup 202 and the base 201. The communication mechanism 206 is in signal connection with the detection mechanism206 and the control mechanism 205, respectively. The power battery is connected to the detection mechanism 206, the communication mechanism, and the control mechanism 105, respectively. The second cup 202 is configured to contact the inner peripheral wall of the pipeline to form a third chamber and a fourth chamber which are separated from each other in a front-and-back direction of the second cup 202. The second chamber and the third chamber are located between the first chamber and the fourth chamber, and the second chamber and the third chamber are in communication with each other. A second pressure relief hole 203 configured to communicate the third chamber and the fourth chamber is disposed on the base 201. A connecting hole 204 is positioned at an end of the base 201 close to the front mandrel 101. The connecting hole 204 has a frustum shape, with the large end of the connecting hole 204 close to the front mandrel 101, and the connecting hole 204 is oriented along the axial direction of the pipeline. An end of the front mandrel 101 matches the connecting hole 204, and the end of the front mandrel 101 is situated in the connecting hole 204. A restoring mechanism 205 is disposed between the end of the front mandrel 101 and the base 201, and the restoring mechanism 205 is configured to keep the front mandrel 101 connected to the base 201 and assist the end of the front mandrel 101 in inserting into the connecting hole 204 after the end of the front mandrel 101 is disengaged from the connecting hole 204.

The in-line detector for geometric deformation of the non-metallic pipeline, equipped with an automatic jam release function (hereinafter may be referred to as an in-line detector) refers to a device configured to detect pipeline deformation and capable of automatically releasing jams. For example, the in-line detector is used for a polyethylene gas transmission pipeline and is a built-in detection device capable of detecting morphology at pipeline elbows and deformed sections and automatically escaping. The in-line detector is disposed inside the pipeline, with its axis parallel to the pipeline axis. The pipeline axis refers to a virtual straight line formed by connecting centers of cross-sections of the pipeline and is consistent with an extension direction of the pipeline.

In some embodiments, the pipeline axis is parallel to the front mandrel 101.

A jam refers to an abnormal operation state where the in-line detector is unable to continue moving forward while inside the pipeline. For example, the jam may include a viscous blockage caused by wax deposition or oil sludge in an oil and gas pipeline.

The term “pipeline deformation” refers to a change in the shape of the pipeline. For example, pipeline deformation may include the inward bending of the inner wall of the pipeline, axial bending of the pipeline, and so on.

The adaptive module 1 refers to a functional module positioned at the front end of the in-line detector along an axial direction of the in-line detector. The adaptive module 1 is designed to adaptively adjust according to a morphology of the pipeline and cooperate to achieve jam release. In some embodiments, the adaptive module 1 may include the front mandrel 101, the first cup 102, the auxiliary support mechanism 103, the first pressure relief hole 104, the control mechanism 105, etc.

The front mandrel 101 refers to a core support component of the adaptive module. The front mandrel 101 is arranged along the axial direction of the in-line detector and is configured to carry components such as the first cup 102. One end of the front mandrel 101 is connected to the base 201 of the detection module 2. More descriptions regarding the detection module 2 and the base 201 may be found in the following content and the related descriptions thereof.

The first cup 102 refers to an elastic sealing member fixed circumferentially on an outer periphery of the front mandrel 101 along the front mandrel 101. The first cup 102 is configured to contact and seal the inner peripheral wall of the pipeline to form the first chamber and the second chamber that are separated from each other in the front-and-back direction of the first cup 102.

In some embodiments, the first cup 102 may serve as a power component of the in-line detector. The first cup 102 pushes the in-line detector to move along the axial direction of the pipeline through a driving pressure difference between the first chamber and the second chamber.

The first chamber refers to a chamber formed at a front side of the first cup 102 and enclosed by the first cup 102 and the inner peripheral wall of the pipeline. In some embodiments, a medium in the pipeline may enter the first chamber, and a pressure difference is formed between the first chamber and the second chamber disposed at a rear side. The pressure difference is the driving pressure difference for driving the in-line detector to move along the axial direction of the pipeline.

The second chamber refers to a chamber formed at a rear side the first cup 102 and enclosed by the first cup 102 and the inner peripheral wall of the pipeline.

The auxiliary support mechanism 103 refers to an auxiliary component arranged circumferentially on the inner side of the first cup 102. The auxiliary support mechanism 103 is configured to enable the first sealing cup to always contact and seal the inner peripheral wall of the pipeline when the pipeline deforms, thereby preventing the first sealing cup from detaching from the inner peripheral wall of the pipeline. More descriptions regarding the first sealing cup may be found in the following content and its related descriptions.

The first pressure relief hole 104 refers to a hole disposed along an axial direction of the front mandrel 101. The first pressure relief hole 104 is configured to connect the first chamber and the second chamber.

The control mechanism 105 refers to a component disposed in the first pressure relief hole 104. The control mechanism 105 is configured to control the opening degree of the first pressure relief hole 104 and implement control of a movement speed of the in-line detector. In some embodiments, the control mechanism 105 may include a cover plate and one or more stoppers. More descriptions regarding the cover plate and the one or more stoppers may be found in the following content and the its related descriptions.

The opening degree of the pressure relief hole refers to a size of an opening of the pressure relief hole, which is used to control a flow rate of the medium in the pipeline passing through the pressure relief hole. In some embodiments, the opening degree of the pressure relief hole may be represented by a percentage value. For example, the opening degree of the pressure relief hole may be 75%, 90%, 100%, or the like.

The movement speed refers to a speed at which the in-line detector travels along the axial direction of the pipeline. In some embodiments, the movement speed may be obtained by a speedometer, a gyroscope, or the like carried by the in-line detector.

In some embodiments, the opening degree of the first pressure relief hole 104 is negatively correlated with the movement speed of the in-line detector. When the opening degree of the first pressure relief hole 104 increases, an amount of the medium in the pipeline flowing from the first chamber to the second chamber through the first pressure relief hole 104 increases, the pressure difference between the first chamber and the second chamber decreases, and a driving force pushing the in-line detector to move forward decreases accordingly, resulting in a decrease in the movement speed of the in-line detector. When the opening degree of the first pressure relief hole 104 decreases, the amount of the medium in the pipeline flowing from the first chamber to the second chamber through the first pressure relief hole 104 decreases, the pressure difference between the first chamber and the second chamber increases, the driving force pushing the in-line detector to move forward increases accordingly, resulting in an increase in the movement speed of the in-line detector.

The detection module 2 refers to a functional module disposed at a rear side of the adaptive module along the axially direction of the in-line detector. The detection module 2 may perform data collection related to the pipeline deformation and cooperate with the adaptive module 1 to achieve jam release. In some embodiments, as shown in FIG. 5 and FIG. 6, the detection module 2 may include a base 201, a second cup 202, a second pressure relief hole 203, a connecting hole 204, a restoring mechanism 205, a detection mechanism 206, or the like.

The base 201 refers to a main support member disposed on the detection module, arranged along the axial direction of the in-line detector, and configured to carry components such as the power battery, the communication mechanism, and the second cup 202.

The power battery refers to a power supply component disposed inside the base 201 and configured to supply power to the detection mechanism, the communication mechanism, or the like.

The communication mechanism refers to a signal transmission component integrated inside the base 201 and configured to transmit signals to the external device and other components.

In some embodiments, the external device may include a ground server, a remote monitoring platform, or the like.

In some embodiments, the ground server may be used to receive and process data (e.g., the movement speed, a location, a three-dimensional morphology map, or the like) transmitted by the communication mechanism.

In some embodiments, the remote monitoring platform may be used to support staff in real-time viewing of an operation trajectory, an operation status, or the like of the in-line detector.

The second cup 202 refers to an elastic member arranged circumferentially around an outer periphery of the base 201 and configured to contact the inner peripheral wall of the pipeline to form the third chamber and the fourth chamber separated from each other in the front-and-back direction of the second cup 202.

The third chamber refers to a chamber located at a front side of the second cup 202 and enclosed by the second cup 202 and the inner peripheral wall of the pipeline. In some embodiments, the second chamber and the third chamber are located between the first chamber and the fourth chamber, and the second chamber and the third chamber are in communication with each other.

The fourth chamber refers to a chamber located at a rear side of the second cup 202 and enclosed by the second cup 202 and the inner peripheral wall of the pipeline.

The detection mechanism 206 refers to a component disposed between the second cup 202 and the base 201 and configured to collect data related to the pipeline deformation. In some embodiments, the detection mechanism 206 may include a plurality of detection arms. More descriptions regarding the plurality of detection arms may be found in the following content and the its related descriptions.

The second pressure relief hole 203 refers to a hole disposed along an axial direction of the base 201 and configured to connect the third chamber and the fourth chamber.

The connecting hole 204 refers to a frustum-shaped hole formed in an end of the base 201 close to the front mandrel 101. A large end of the connecting hole 204 faces the front mandrel 101 and is configured to match and fit with one end of the front mandrel 101 for connection, i.e., one end of the front mandrel 101 is inserted into the connecting hole 204.

The large end of the connecting hole 204 refers to an end of the connecting hole 204 with a larger diameter and facing the front mandrel 101.

In some embodiments, a frustum-shaped structure facilitates resetting of the front mandrel 101 after the front mandrel 101 is disengaged from the connecting hole 204.

The restoring mechanism 205 refers to a component disposed in the connecting hole 204 and configured to maintain connection between the front mandrel 101 and the base 201 (i.e., maintain connection between the adaptive module 1 and the detection module 2).

In some embodiments, when the in-line detector experiences the jam and the first pressure relief hole 104 is in a fully closed state, the driving pressure difference in the front-and-back direction of the first cup 102 reaches a maximum, and a thrust from the medium in the pipeline pushes the front mandrel 101 to impact forward, causing one end of the front mandrel 101 to disengage from the connecting hole 204. When the first pressure relief hole 104 switches to a fully open state, the driving pressure difference drops sharply, and a first spring of the restoring mechanism 205 generates a pulling force to pull the front mandrel 101 to reset. An alternating action of the thrust and the pulling force causes the in-line detector to oscillate axially within the pipeline, thereby assisting the in-line detector in releasing the jam. More descriptions may be found in the following content and its related descriptions.

In some embodiments, one end of the restoring mechanism 205 is fixedly connected to the base 201, and another end of the restoring mechanism 205 is fixedly connected to the front mandrel 101.

In some embodiments of the present disclosure, the adaptive module and the detection module can change with variations of the pipeline when moving within the pipeline. The adaptive module and the detection module can disengage from each other to prevent the detector from being jammed. Two ends of the restoring mechanism remain connected to the adaptive module and the detection module, and the restoring mechanism can assist in restoring the connection between the adaptive module and the detection module to an initial state, thereby automatically releasing a jammed state of the in-line detector within the pipeline and improving the applicability of the in-line detector under complex operation conditions.

In some embodiments of the present disclosure, when the in-line detector for geometric deformation of the non-metallic pipeline with the automatic jam release function is in use, the adaptive module and the detection module can change with variations of the pipeline when moving within the pipeline. The adaptive module and the detection module can disengage from each other to prevent the in-line detector from being jammed, and the restoring mechanism can assist in restoring the adaptive module and the detection module to the initial state. Two ends of the restoring mechanism remain connected to the adaptive module and the detection module, so that automatic release of the jammed state of the in-line detector within the pipeline is achieved, and the applicability of the in-line detector under complex operation conditions is improved. The in-line detector for geometric deformation of the non-metallic pipeline with the automatic jam release function solves problems existing in the prior art: most of existing in-line detectors for geometric deformation of pipelines are designed for steel pipelines, detection arms of the existing in-line detectors are in rigid contact with a wall surface of the pipeline, which may easily scratch the pipeline wall and damage the pipeline; meanwhile, the design of the existing in-line detectors for geometric deformation does not fully consider the passing capacity of the in-line detectors at elbows and deformed locations, resulting in the in-line detectors still being prone to jamming during use, especially in the field of deformation detection for non-metallic pipelines, relevant in-line detectors for geometric deformation are even scarcer on the market.

In some embodiments, the restoring mechanism 205 includes a first spring. One end of the first spring is fixed on the base 201, another end of the first spring is fixed on the front mandrel 101, and the first spring is located within the connecting hole 204.

The first spring refers to an elastic member that sleeves an outer periphery of a lower end of the front mandrel 101 and is embedded in the connecting hole 204. One end of the first spring is fixedly connected to a bottom of the connecting hole 204 of the base 201, and another end of the first spring is fixedly connected to one end of the front mandrel 101 inserted into the connecting hole 204. The first spring is configured to provide a resetting elastic force to maintain the connection between the front mandrel 101 and the base 201, and assist the in-line detector in releasing the jam.

In some embodiments of the present disclosure, by using the first spring in the restoring mechanism and disposing the first spring in the connecting hole, the connection between the front mandrel and the base can be stably maintained and the resetting elastic force when the front mandrel disengages from the connecting hole can be quickly provided. Therefore, compactness and resetting reliability of the restoring mechanism are improved, thereby ensuring rapid escape and continuous operation of the in-line detector after jamming.

FIG. 4 is a schematic diagram illustrating a top view of an in-line detector for geometric deformation of a non-metallic pipeline with an automatic jam release function according to some embodiments of the present disclosure.

In some embodiments, as shown in FIG. 1 and FIG. 4, the first cup 102 includes a first fixed cup 1021. The first fixed cup 1021 is annular and fixed on an outer peripheral surface of the front mandrel 101. A first sealing cup 1022 is connected to an outer circle of the first fixed cup 1021, and the first sealing cup 1022 has an annular structure.

The first fixed cup 1021 refers to a fixed component in an annular shape. The first fixed cup 1021 is coaxial with the front mandrel 101 and fixed on the outer peripheral surface of the front mandrel 101. The first fixed cup 1021 is configured to connect the front mandrel 101 and the first sealing cup 1022, and provide installation support for the first sealing cup 1022.

The first sealing cup 1022 refers to an annular sealing component. An inner circle of the first sealing cup 1022 is connected to the outer circle of the first fixed cup 1021. The outer circle is configured to contact and seal the inner peripheral wall of the pipeline.

The inner circle refers to an edge of the cup close to the front mandrel 101. The outer circle refers to an edge of the cup away from the front mandrel 101.

In some embodiments of the present disclosure, the first cup adopts a split coaxial structure of the first fixed cup and the first sealing cup. The split coaxial structure ensures coaxial installation of the first cup with the front mandrel and the non-metallic pipeline, improves assembly stability and deformation adaptability of the first cup, and achieves more reliable contact and sealing between the first cup and the inner peripheral wall of the pipeline, thereby effectively ensuring the separation effect between the first chamber and the second chamber.

In some embodiments, the auxiliary support mechanism 103 includes a second spring. One end of the second spring is fixed on the first fixed cup 1021, and another end of the second spring is fixed on the first sealing cup 1022. In some embodiments, a material of the first cup 102 is a high-wear-resistance and high-elasticity polyurethane material, or the like.

In some embodiments of the present disclosure, the auxiliary support mechanism adopts the second spring. Two ends of the second spring are respectively fixed on the first fixed cup and the first sealing cup, so that a continuous and stable radial supporting elastic force is provided for the first sealing cup, and the first sealing cup is ensured to always closely fit the inner peripheral wall of the non-metallic pipeline when the shape of the pipeline changes, thereby further improving sealing reliability, and ensuring effective separation between the first chamber and the second chamber.

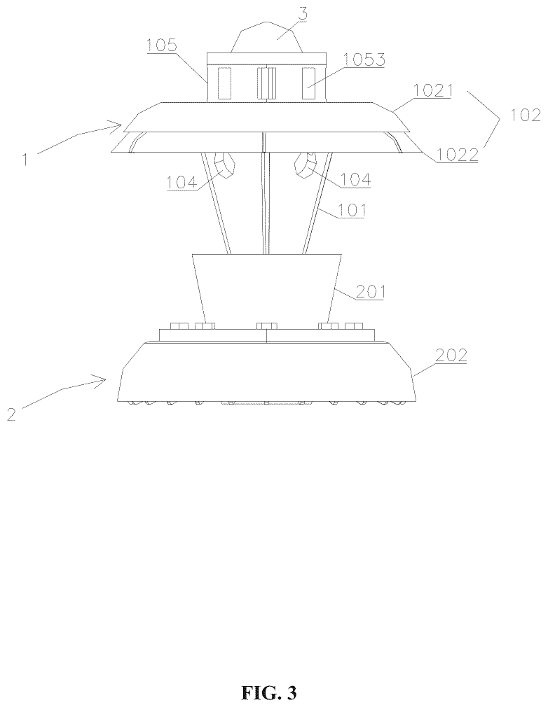

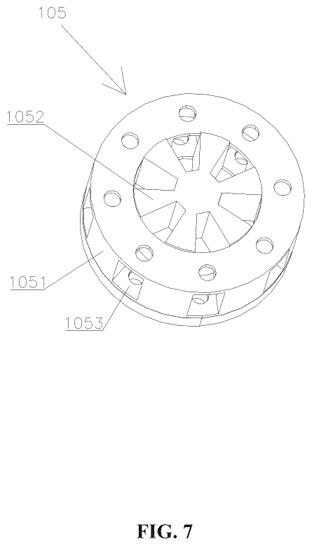

FIG. 3 is a schematic diagram illustrating a front view of an in-line detector for geometric deformation of a non-metallic pipeline with an automatic jam release function according to some embodiments of the present disclosure. FIG. 7 is a schematic structural diagram illustrating a control mechanism according to some embodiments of the present disclosure.

In some embodiments, as shown in FIG. 3 and FIG. 7, the control mechanism 105 includes a cover plate 1051 and one or more stoppers 1052. The cover plate 1051 covers an end of the first pressure relief hole 104 located at the first chamber. One or more through holes 1053 are disposed in the cover plate 1051. The one or more through holes 1053 are configured to communicate the first chamber and the first pressure relief hole 104. A driving mechanism configured to drive the one or more stoppers 1052 to move and cause the one or more stoppers 1052 to block or open the one or more through holes 1053 is disposed on the front mandrel 101.

In some embodiments, the first pressure relief hole 104 is connected to the first chamber. The opening degree of the first pressure relief hole 104 may affect the flow rate of the medium in the pipeline entering the first chamber, which changes a medium pressure distribution in the first chamber and the second chamber, affecting the driving pressure difference formed between the first chamber and the second chamber, and ultimately affecting the movement speed of the in-line detector. More descriptions regarding the movement speed may be found in the foregoing description.

More descriptions regarding the control mechanism may be found in FIG. 1 and its related descriptions.

The cover plate 1051 refers to a sealing component covering an end of the first pressure relief hole 104 close to the first chamber. The cover plate 1051 is provided with the one or more through holes 1053. The one or more through holes 1053 are configured to connect the first chamber and the first pressure relief hole 104 to provide a channel for flow of the medium (e.g., gas, liquid, etc.) in the pipeline.

The one or more stoppers 1052 refer to blocking components adapted to one or more the through holes 1053. The one or more stoppers 1052 may achieve partial blocking, complete blocking, or opening of the one or more through holes 1053 through displacement, thereby controlling an on-off state of the first pressure relief hole 104. A plurality of stoppers 1052 may be provided, which may be preset according to actual requirements.

The driving mechanism refers to a power component disposed on the front mandrel 101. The driving mechanism is also an execution component of the control mechanism and configured to drive the one or more stoppers 1052 to move along an axial direction of the one or more through holes 1053 to switch the one or more stoppers 1052 to a state of partial blocking, complete blocking, or opening of the one or more through holes 1053, achieving adjustment of the opening degree of the first pressure relief hole 104. For example, the driving mechanism may be a motor, or the like.

In some embodiments of the present disclosure, the control mechanism connects the first chamber and the first pressure relief hole through the cover plate and the one or more through holes, and cooperates with the driving mechanism to drive the one or more stoppers to move to partially block, completely block, or open the one or more through holes, so that the opening degree of the first pressure relief hole can be accurately adjusted, thereby flexibly controlling the flow rate of the medium in the pipeline, achieving stable control of the movement speed of the in-line detector, and ensuring smooth movement and detection accuracy of the in-line detector in the non-metallic pipeline.

In some embodiments, a plurality of through holes 1053 are uniformly distributed along a circumferential direction on the cover plate 1051 at intervals, and the one or more stoppers 1052 are arranged corresponding to the plurality of through holes 1053.

A count of the through holes may be preset according to actual requirements. The count of the one or more stoppers 1052 may be equal to the counts of the through holes 1053. For example, one through hole 1053 is correspondingly provided with one stopper 1052, or the like.

In some embodiments of the present disclosure, the cover plate adopts the design of the plurality of through holes uniformly distributed along the circumferential direction, and the stoppers correspond one-to-one with the through holes, so that a control range of the flow rate of the medium is broadened, achieving more precise adjustment of the movement speed of the in-line detector, thereby adapting to different operation condition requirements of the non-metallic pipeline.

In some embodiments, the second cup 202 includes a second sealing cup. The second sealing cup has an annular structure, and the second sealing cup is fixed on an outer peripheral surface of the base 201.

The second sealing cup refers to an annular sealing component. The second sealing cup is coaxial with the base 201 and the non-metallic pipeline and fixed on the outer peripheral surface of the base 201. An outer circle of the second sealing cup is configured to contact and seal the inner peripheral wall of the non-metallic pipeline.

In some embodiments of the present disclosure, the second sealing cup is coaxially fixed with the base and the non-metallic pipeline, and the annular structure of the second sealing cup can closely fit the inner peripheral wall of the pipeline, so that chamber separation and sealing can be effectively achieved, improving the sealing reliability of the in-line detector.

FIG. 6 is a schematic diagram illustrating an A-A sectional view of FIG. 4 according to some embodiments of the present disclosure.

In some embodiments, as shown in FIG. 6, the detection mechanism 206 includes a plurality of detection arms 2061. The plurality of detection arms 2061 are uniformly distributed along a circumferential direction of the base 201. One end of each of the plurality of detection arms 2061 is hinged on the base 201, another end of each of the plurality of detection arms 2061 abuts a position where the second sealing cup contacts the pipeline. The second sealing cup is located between the pipeline and the other end of each of the plurality of detection arms 2061, and a third spring 2062 is disposed between each of the plurality of detection arms 2061 and the base 201.

In some embodiments, the detection mechanism 206 further includes a data acquisition card. The data acquisition card is configured to collect pipeline deformation information detected based on the plurality of detection arms 2061.

The pipeline deformation information refers to information related to the pipeline deformation.

In some embodiments, the pipeline deformation information may include an angle variation, a rate of angle variation, a pipeline deformation quantity, a deformation rate, a degree of pipeline wear, a three-dimensional deformation data set, etc. More descriptions may be found in the following related descriptions.

The plurality of detection arms 2061 refer to rod-shaped detection components uniformly arranged along the circumferential direction of the base 201. One end of each of the plurality of detection arms 2061 is hinged on the base 201 and capable of rotating about a hinge point. Another end of each of the plurality of detection arms 2061 abuts the position where the second sealing cup contacts the pipeline. The second sealing cup is sandwiched between the pipeline and another end of each of the plurality of detection arms 2061 and configured to convert deformation of the second sealing cup into angular displacement of each of the plurality of detection arms 2061 to feed back data related to pipeline deformation.

The data acquisition card refers to a signal acquisition component electrically connected to the plurality of detection arms 2061. The data acquisition card is configured to collect an electrical signal (e.g., a resistance change signal, a voltage signal, etc.) corresponding to the angular displacement of each of the plurality of detection arms in real time and convert the electrical signal into a transmittable digital signal, providing data support for calculation of the pipeline deformation quantity, or the like. More descriptions regarding the pipeline deformation quantity may be found in the following descriptions.

The third spring refers to an elastic component disposed one-to-one between each of the plurality of detection arms and the base. The third spring is configured to provide a continuous elastic pre-tightening force for the detection arm 2061.

In some embodiments of the present disclosure, the detection arms are uniformly distributed along the circumferential direction of the base and hinged on the base, the detection arms cooperate with the third spring to apply a stable supporting force to the second sealing cup, causing the second sealing cup to always closely abut the inner peripheral wall of the pipeline. Another end of each of the plurality of detection arms abuts the position where the second sealing cup contacts the pipeline, which synchronously perceives the deformation state of the cup, thereby ensuring the sealing effect of the cup while improving the accuracy of pipeline deformation detection, and adapting to the detection requirements of the non-metallic pipeline.

In some embodiments, an anti-collision head 3 is disposed on the front mandrel 101, and the anti-collision head 3 is configured to prevent the in-line detector from damaging internal components of the pipeline due to excessive speed or collisions.

In some embodiments, the speed may also be referred to as the movement speed.

The internal components of the pipeline refer to built-in components of the pipeline. In some embodiments, the internal components may include a built-in sealing ring at a built-in pipeline interface, a guide plate in the pipeline, a wear-resistant inner liner at an elbow of the pipeline, etc. More descriptions regarding the pipeline interface may be found in the following descriptions.

In some embodiments, the speed of the in-line detector being too fast refers to the speed exceeding a preset speed threshold. The speed threshold may be preset according to actual requirements.

The anti-collision head 3 refers to a buffer protection component disposed at a front end of the front mandrel 101. The anti-collision head 3 is configured to absorb a collision impact force when the movement speed of the in-line detector is too fast or when the in-line detector passes through the elbow of the pipeline to prevent the internal components from being damaged due to impact. In some embodiments, the anti-collision head may be made of an elastic material (e.g., rubber, polyurethane, etc.).

In some embodiments of the present disclosure, by arranging the anti-collision head at the front end of the front mandrel, the impact force during high-speed movement of the in-line detector or when passing through the elbow can be effectively absorbed, damage to internal components can be avoided, and structural integrity and operation stability of the in-line detector can be ensured.

In some embodiments, the anti-collision head 3 is located at the front end of a displacement direction of the front mandrel 101, and the anti-collision head 3 is made of explosion-proof metal, explosion-proof polyurethane, etc.

In some embodiments, the displacement direction may also be referred to as a travel direction.

In some embodiments of the present disclosure, the anti-collision head uses the material of explosion-proof metal or explosion-proof polyurethane material and is arranged at the front end of the displacement direction of the front mandrel, so that the collision impact force can be effectively absorbed to protect the internal components, and sparks caused by collision and friction can be avoided to adapt to explosion-proof operation conditions, thereby ensuring the use safety of the in-line detector in pipelines conveying flammable and explosive media.

In some embodiments, a method for using the in-line detector includes the following operations:

S1. deploying the in-line detector in a valve chamber using a portable launcher.

S2. driving the in-line detector to move by a driving pressure difference formed in a front-and-back direction of the first cup 102 on the in-line detector, and adjusting the opening degree of the first pressure relief hole 104 through the control mechanism 105 to precisely control the movement speed of the in-line detector and maintain the movement speed stable.

S3. The in-line detector continuously moving along the pipeline axis with the medium inside the pipeline, recording angle variations between the plurality of detection arms 2061 and the pipeline axis by using the plurality of detection arms 2061 on the detection mechanism 206, the plurality of detection arms 2061 swinging about the hinge point on the base 201; a processor calculating a distance between each of the plurality of detection arms 2061 and a pipe wall when each of the plurality of detection arms 2061 is pressed down or relaxed, based on a preset length of each of the plurality of detection arms 2061, and then calculating a deformation quantity of the pipeline; and the processor performing signal communication with the external device outside the pipeline via an ultra-low frequency transmitter of the communication mechanism, thereby achieving positioning of a movement mileage of the in-line detector.

S4. recovering the in-line detector using a portable receiver in the valve chamber, importing data from the data acquisition card inside the detection mechanism 206 of the in-line detector into a computer for data analysis of pipeline deformation conditions.

When the above in-line detector for geometric deformation of the non-metallic pipeline with the automatic jam release function is in use, the medium (e.g., natural gas, water, etc.) is conveyed inside the pipeline. In an initial state, after the in-line detector is placed inside the pipeline, the driving pressure difference is formed by an interference fit and sealing between the first cup 102 and the inner wall of the pipeline, thereby achieving self-propelled movement of the in-line detector.

When the in-line detector moves to a position where a diameter of the pipeline suddenly increases, pressure in the first chamber in front of the in-line detector instantly decreases, and the first cup 102 becomes jammed under the action of the auxiliary support mechanism 103. Alternatively, when the in-line detector becomes jammed at the elbow of the pipeline, the driving pressure difference in the front-and-back direction of the first cup 102 on the in-line detector increases, i.e., the pressure difference between the first chamber and the second chamber increases. Since the in-line detector is jammed and unable to move, pressure in the second chamber continuously increases under the action of the medium inside the pipeline. The first cup 102 is subjected to a traction force opposite to the travel direction of the in-line detector, thereby driving the front mandrel 101 to disengage from the connecting hole 204 of the detection module 2 to cause an adaptive module 1 to move inside the pipeline. The in-line detector drives the detection module 2 through the restoring mechanism 205 to enter the jammed location of the pipeline together. After the in-line detector passes through the jammed location of the pipeline, one end of the front mandrel 101 is inserted into the connecting hole 204 under the action of the first spring in the restoring mechanism 205, thereby restoring the adaptive module 1 and the detection module 2 to the initial state, and achieving adaptation to deformation sizes of different pipeline. Meanwhile, each of the plurality of detection arms 2061 drives the second cup 202 to closely fit the inner wall of the pipeline under the action of the third spring 2062 to continuously perform deformation detection. Since the control mechanism 105 is disposed at the first pressure relief hole 104, the in-line detector is able to adjust the opening degree of the first pressure relief hole 104 through the control mechanism 105 to control a magnitude of the pressure difference between the first chamber and the second chamber, thereby stabilizing the movement speed of the in-line detector inside the pipeline.

No occlusion or control component is disposed at the second pressure relief hole 203. Accordingly, pressure among the second chamber, the third chamber, and the fourth chamber remains substantially consistent, thereby ensuring stability of the detection process.

In some embodiments, the in-line detector for geometric deformation of the non-metallic pipeline with the automatic jam release function further includes the processor. The processor is disposed on the base 201 of the detection module 2, and the processor is configured to: obtain, through the detection mechanism 206 based on a first time interval, an angle variation and a rate of angle variation of a plurality of detection arms 2061 relative to the pipeline axis; adjust the opening degree of the first pressure relief hole 104 based on the rate of angle variation in advance.

In some embodiments, the processor may be disposed in an independent sealed cavity inside the base 201, at an inner side position of the base 201 facing the detection module 2, or the like. The position of the processor on the base 201 may be set according to requirements.

More descriptions regarding the detection module 2, the base 201, the detection mechanism 206, the plurality of detection arms 2061, the first pressure relief hole 104, and the opening degree may be found in the foregoing content and its related descriptions.

In some embodiments, the processor is connected to a power circuit and is in communication connection with sensors of the in-line detector, the control mechanism 105, etc.

The sensors may include an angle sensor, a pressure sensor, a displacement sensor, an odometer sensor, etc.

In some embodiments, the angle sensor may be integrated at a hinge point of the detection arm 2061 for detecting an angle between the detection arm 2061 and the pipeline axis.

In some embodiments, the pressure sensor may be deployed in cavities of the first chamber and the second chamber, respectively, and configured to monitor pressure in the two chambers, calculate the driving pressure difference, and feed back to the control mechanism 105 to control the opening degree of the first pressure relief hole 104.

In some embodiments, the displacement sensor may be disposed at an end of each of the plurality of detection arms 2061 (i.e., another end of the hinge point of each of the plurality of detection arms) for directly detecting a radial displacement amount of each of the plurality of detection arms. The displacement sensor may be integrated on the control mechanism 105 for detecting a real-time displacement amount of the one or more stoppers 1052 or the cover plate 1051.

In some embodiments, the odometer sensor may be disposed on the front mandrel 101 of the in-line detector for detecting the movement mileage and the movement speed of the in-line detector. More descriptions regarding the movement speed may be found in the foregoing content and its related descriptions. More descriptions regarding the movement mileage may be found in the following content and its related descriptions.

Positions of the sensors may be set according to actual requirements, which are not limited herein.

In some embodiments, the processor may include one or more sub-processing devices (e.g., a single-core processing device or a multi-core multi-chip processing device). Merely by way of example, the processor may include a central processing unit (CPU), an application-specific integrated circuit (ASIC), a microprocessor, a microcontroller, or the like, or any combination thereof.

The first time interval refers to a time interval at which the detection mechanism 206 collects the angle variation of the detection arm 2061. For example, the first time interval may be 5 ms, 10 ms, etc.

In some embodiments, the first time interval may be determined in a plurality of ways. For example, the first time interval may be a preset reference interval.

The preset reference interval is inversely proportional to a spatial data resolution. The spatial data resolution may reflect data accuracy. Different positions inside the pipeline require different spatial data resolutions. The processor may preset spatial data resolutions corresponding to different positions inside the pipeline according to actual requirements. The processor may determine preset reference intervals for different positions inside the pipeline based on the preset spatial data resolutions.

In some embodiments, the first time interval is negatively correlated with the movement speed of the in-line detector. Setting of the first time interval needs to ensure that an instantaneous angle variation caused by a geometric mutation of the pipeline is also obtained when the in-line detector moves at a high speed.

In some embodiments, the processor may dynamically adjust the first time interval by combining a preset reference speed and the movement speed of the in-line detector. For example, the first time interval is a product of a ratio of the preset reference speed to the movement speed and the preset reference interval.

The preset reference speed refers to a basic movement speed preset based on a pipeline detection scenario. For example, the preset reference speed may be 0.5 m/s, etc. In some embodiments, the processor may set the preset reference speed in advance by referring to a conventional flow velocity (e.g., 0.3 m/s-1.5 m/s) of the medium inside the pipeline, a preset movement range of the in-line detector, etc.

In some embodiments, when a diameter of the pipeline is uniform without deformation, one end of each of the plurality of detection arms 2061 is hinged on the base, and another end of each of the plurality of detection arms 2061 abuts against the second sealing cup. At this time, an angle between an extension direction of each of the plurality of detection arms 2061 and the pipeline axis does not change. When the pipeline deforms to squeeze the second sealing cup, each of the plurality of detection arms 2061 rotates about the hinge point, and the angle between each of the plurality of detection arms 2061 and the pipeline axis changes.

The rate of angle variation refers to a change amplitude, per unit time (i.e., the first time interval), of the angle between each of the plurality of detection arms and the pipeline axis obtained through continuous collection. The rate of angle variation is used to reflect a rate of the pipeline deformation.

In some embodiments, the processor may determine the angle variation (i.e., a difference between two angles, which may also be referred to as an angle variation quantity) based on two angles between each of the plurality of detection arms 2061 and the pipeline axis collected by the detection mechanism 206 at two time points of the first time interval. The processor may determine a ratio of the angle variation to the first time interval as the rate of angle variation. The processor may continuously determine a plurality of angle variations and a plurality of rates of angle variation based on the above manner.

In some embodiments, the processor may adjust the opening degree of the first pressure relief hole 104 in advance based on the rate of angle variation in a plurality of ways.

For example, when the rate of angle variation exceeds a preset variation threshold, it indicates that the in-line detector is about to enter a severely deformed region (e.g., a severe depression, a sharp bend, etc.). The processor may send an instruction to the control mechanism 105 to increase the opening degree of the first pressure relief hole 104 in advance, and reduce the driving pressure difference formed in the front-and-back direction of the first cup 102 (the larger the driving pressure difference, the higher the movement speed or acceleration of the in-line detector), enabling the in-line detector to smoothly decelerate to enter the deformed region.

In some embodiments, the preset variation threshold may be determined through experimental calibration. A test pipeline having the same specification as a pipeline whose rate of angle variation needs to be detected is pre-selected, deformed regions (e.g., depressions, sharp bends, etc.) with different degrees of severity are set in the test pipeline by simulation. The in-line detector is allowed to perform simulated detection in the test pipeline and record the rate of angle variation before entering each deformation region. A minimum rate of angle variation just before entering the deformation region is taken, and a safety margin of 10% to 20% is added to the minimum rate of angle variation to obtain the preset variation threshold.

In some embodiments, the processor may use the driving mechanism through the control mechanism 105 to drive the one or more stoppers 1052 to move, so that the one or more stoppers 1052 gradually disengage from the one or more through holes 1053 on the cover plate 1051, achieving a gradual increase in the opening degree of the first pressure relief hole 104, thereby slowly reducing the driving pressure difference in the front-and-back direction of the first cup 102 to avoid a sudden change in the movement speed of the in-line detector caused by a sharp drop in the driving pressure difference.

In some embodiments, after the processor confirms that the in-line detector has safely entered the deformation region (e.g., the rate of angle variation decreases and is stable below in a safety threshold), the processor may use the driving mechanism through the control mechanism 105 to quickly re-block the first pressure relief hole 104, so as to reduce opening degree of the first pressure relief hole 104 to the re-establish a sufficient driving pressure difference to drive the in-line detector through the deformation region. The safety threshold may be set manually based on historical experience.

In some embodiments, a specific process for the driving mechanism to block the first pressure relief hole 104 is as follows: the control mechanism 105 drives the one or more stoppers 1052 to move through the driving mechanism to make the one or more stoppers 1052 block the one or more through holes on the cover plate 1051 to indirectly block a flow channel of the first pressure relief hole 104.

In some embodiments of the present disclosure, the processor obtains the angle variation and the rate of angle variation of each of the plurality of detection arms in real time, achieving early prediction of impact risks such as sharp bends or severe deformations in the pipeline. The processor adjusts the opening degree of the first pressure relief hole in advance to achieve smooth deceleration, which reduces the risk of mechanical damage caused by hard collisions between each of the plurality of detection arms, the detection module, and the inner peripheral wall of the pipeline, thereby enhancing the safety of the in-line detector in complex pipelines.

In some embodiments, the processor is further configured to: determine a plurality of deformation quantities of the pipeline based on the angle variation; determine a deformation rate based on the plurality of deformation quantities; determine the opening degree of the first pressure relief hole 104 based on the deformation rate; determine a target occlusion area of each of the one or more through holes 1053 by each of the one or more stoppers 1052 by querying an opening degree data table based on the opening degree of the first pressure relief hole 104; control, by using the driving mechanism, the one or more stoppers 1052 to occlude the one or more through holes 1053 based on the target occlusion area.

More descriptions regarding the angle variation, the first pressure relief hole 104, the opening degree, the one or more stoppers 1052, the one or more through holes 1053, and the driving mechanism may be found in the foregoing content and its related descriptions.

The deformation quantity of the pipeline refers to an actual radial deformation quantity of the pipeline at an axial position. For example, if the pipeline deformation is a pipeline depression, the deformation quantity of the pipeline is a radial depression height at the pipeline depression.

In some embodiments, the processor may calculate actual radial distances corresponding to two time points, respectively, based on two angles between each of the plurality of detection arms 2061 and the pipeline axis collected at the two time points of the first time interval in combination with a preset total length of each of the plurality of detection arms 2061. The calculation may use a trigonometric function (e.g., a sine function). The actual radial distance refers to a distance from a pipe wall of the pipeline to the pipeline axis. The processor may determine a difference between the actual radial distances corresponding to the two time points, respectively, as the deformation quantity of the pipeline. The processor may continuously obtain the plurality of deformation quantities of the pipeline corresponding to a plurality of consecutive first time intervals through the above manner.

The deformation rate refers to a magnitude of the pipeline deformation over time.

In some embodiments, the deformation rate may be a ratio of the deformation quantity of the pipeline to the first time interval.

In some embodiments, the opening degree of the first pressure relief hole 104 is positively correlated with the deformation rate. For example, the larger the deformation rate, the larger the opening degree, and the faster the deceleration speed of the in-line detector, achieving smooth speed control of the in-line detector. If the deformation rate is 0, which indicates no deformation in the pipeline, a current opening degree does not need to be adjusted.

In some embodiments, the opening degree of the first pressure relief hole 104 is a sum of the current opening degree and a product of the current opening degree and an opening coefficient. The opening coefficient is a ratio of the deformation rate to a pipeline radius.

In some embodiments, the processor may detect a real-time displacement amount of the one or more stoppers 1052 or the cover plate 1051 through a displacement sensor on the control mechanism 105. The processor may determine a product of a ratio of the real-time displacement amount of the one or more stoppers 1052 or the cover plate 1051 to a maximum displacement amount of the one or more stoppers 1052 or the cover plate 1051 and a maximum opening degree (100%) as the current opening degree.

In some embodiments, the maximum displacement amount refers to an arc length corresponding to a single through hole 1053 in a circumferential direction. The real-time displacement amount of the one or more stoppers 1052 and the real-time displacement amount of the cover plate 1051 are the same.

The target occlusion area refers to an area of the one or more through holes 1053 on the cover plate 1051 that the one or more stoppers 1052 need to occlude. The target occlusion area is used to adjust the opening degree of the first pressure relief hole 104 by adjusting the driving pressure difference. More descriptions regarding the driving pressure difference may be found in the foregoing content and its related descriptions.

In some embodiments, the processor may query the opening degree data table based on the opening degree of the first pressure relief hole 104 to obtain the target occlusion area.

The opening degree data table may include a correspondence between different opening degrees of the first pressure relief hole 104 and different target occlusion areas. The opening degree data table may be preset.

In some embodiments, data in the opening degree data table may be determined based on structural parameters of the in-line detector. The structural parameters may include a dimension (e.g., a count of through holes 1053 and an area of a single through hole 1053) of the one or more through holes 1053.

In some embodiments, the processor may use the driving mechanism to control the one or more stoppers 1052 to occlude the one or more through holes 1053 on the cover plate 1051, so that the area of the one or more through holes on the cover plate 1051 occluded by the one or more stoppers 1052 reaches the target occlusion area.

In some embodiments of the present disclosure, the opening degree of the first pressure relief hole and the target occlusion area of each of the one or more stoppers are dynamically determined based on the deformation quantity and the deformation rate of the pipeline, which achieves precise speed control under pipeline deformation prediction, avoids sudden speed changes, ensures stability of the in-line detector when passing through the deformation region, and ensures that the deceleration process is smooth and controllable.

In some embodiments, the processor is further configured to: obtain the movement speed of the in-line detector every second time interval; in response to the movement speed or a movement mileage satisfying a preset condition, control the driving mechanism to drive the one or more stoppers to perform periodic reciprocating motion to periodically adjust the opening degree of the first pressure relief hole 104.

The second time interval refers to a preset time interval at which the processor obtains the movement speed of the in-line detector. The second time interval is used to monitor a jam state of the pipeline. For example, the second time interval may be 1 s, 2 s, etc.

In some embodiments, the second time interval may be preset by balancing a monitoring accuracy requirement for jamming and power consumption of the in-line detector. The second time interval may be greater than the first time interval.

In some embodiments, the processor may obtain the movement speed of the in-line detector every second time interval through a speedometer, a gyroscope, or the like.

In some embodiments, the processor may obtain the movement mileage of the in-line detector every second time interval via a positioning component, or the like. The positioning component may include an odometer sensor, an inertial measurement unit (IMU), or the like.

The preset condition refers to a condition for determining that the in-line detector is jammed. In some embodiments, the preset condition may include a movement speed preset condition and a movement mileage preset condition.

In some embodiments, the movement speed preset condition may include that the movement speed of the in-line detector remains zero or is less than a preset speed threshold, and a duration exceeds a preset jam determination threshold (e.g., the duration is 20 seconds, etc.), it is determined that the in-line detector is jammed.

In some embodiments, the preset speed threshold may be preset by the processor. Merely by way of example, if a normal movement speed of the in-line detector in the pipeline is 1.5 m/s, the preset speed threshold may be set to 0.3 m/s.

The movement mileage refers to a mileage along the pipeline axis of the in-line detector.

In some embodiments, the movement mileage preset condition refers to that the movement mileage of the in-line detector within a preset time period is less than a preset mileage threshold. In response to the movement mileage of the in-line detector satisfying the movement mileage preset condition, it is determined that the in-line detector jammed.

In some embodiments, the preset mileage threshold may be a product of the preset speed threshold and the preset time period.

In some embodiments, in response to the movement speed or the movement mileage satisfying the preset condition, the processor may periodically adjust the opening degree of the first pressure relief hole 104. For example, the processor may send a periodic action instruction to the driving mechanism through the control mechanism 105. The driving mechanism drives the one or more stoppers 1052 to periodically reciprocate along a travel direction of the in-line detector, thereby controlling the first pressure relief hole 104 to cyclically switch between a fully closed state (i.e., the opening degree is 0%) and a fully open state (i.e., the opening degree is 100%).

In some embodiments, the fully closed state refers to that when the opening degree of the first pressure relief hole 104 is 0%, the driving pressure difference in the front-and-back direction of the first cup 102 reaches a maximum. In this case, a thrust from the medium in the pipeline on the first cup 102 may overcome a pulling force of the restoring mechanism (i.e., the first spring), thereby pushing the front mandrel 101 forward along the travel direction of the in-line detector for an impact.

In some embodiments, the fully open state refers to that when the pressure relief opening degree of the first pressure relief hole 104 is 100%, the driving pressure difference in the front-and-back direction of the first cup 102 drops sharply. In this case, the thrust from the medium in the pipeline on the first cup 102 is less than the pulling force of the restoring mechanism 205 (i.e., the first spring). The stretched first spring generates a restoring force to pull the front mandrel 101 backward along a direction opposite to the travel direction of the in-line detector.

In some embodiments, the first pressure relief hole 104 is cyclically switched between the fully closed state (generating the medium thrust) and the fully open state (generating the spring pulling force), and the medium thrust and the spring pulling force periodically and alternately act on the in-line detector, cause the in-line detector to axially oscillate in the pipeline (i.e., to reciprocally shake back and forth along the direction of the pipeline axis), thereby effectively breaking a blocking state of static friction between the first cup 102 and the inner peripheral wall of the pipeline, and assisting the adaptive module 1 in breaking through a jam point.

In some embodiments of the present disclosure, the movement speed is obtained every second time interval. In response to the movement speed or the movement mileage satisfying the preset condition, the in-line detector is in the jammed state. The one or more stoppers are controlled to reciprocate to adjust the opening degree of the first pressure relief hole, causing the in-line detector to form the axial oscillation. The axial oscillation can convert high-viscosity static friction caused by wax deposition, oil sludge, or the like, in the pipeline into smaller dynamic friction or mixed friction, thereby reducing jam breaking resistance, significantly improving the passing capacity of the in-line detector, reducing detection interruption, and ensuring detection continuity of the in-line detector.

In some embodiments, a period for adjusting the opening degree of the first pressure relief hole 104 is adjusted by querying a period data table based on a service life of the pipeline and a degree of pipeline wear.

In some embodiments, the period is the same as a period for controlling the driving mechanism to drive the one or more stoppers to reciprocate periodically, and as a period for periodically adjusting the opening degree of the first pressure relief hole.

In some embodiments, the processor may extract a cumulative service life of the pipeline from an official operation start time to a current detection time by retrieving basic archive data stored in a ground server, querying historical records such as a pipeline operation log, or the like. The processor may determine the cumulative service life as the service life of the pipeline.

In some embodiments, the degree of pipeline wear refers to a degree of loss of the inner peripheral wall of the pipeline due to factors such as medium flow, impurity friction, microbial corrosion, or the like. In some embodiments, the degree of pipeline wear may be expressed as a percentage value. For example, the degree of pipeline wear may be 10%, 20%, or the like.

In some embodiments, the processor may determine a pipeline thickness loss rate as the degree of pipeline wear.

In some embodiments, the processor may calculate a difference between a pipeline design wall thickness and a current measured average wall thickness, and determine a percentage value of a ratio of the difference to the pipeline design wall thickness as the pipeline thickness loss rate. The processor may determine the pipeline thickness loss rate as the degree of pipeline wear.

In some embodiments, the pipeline design wall thickness refers to a wall thickness value determined during an engineering design phase of the pipeline. The current measured average wall thickness may be an average value calculated after a detection device measures a current actual wall thickness.

In some embodiments, the detection device may include an ultrasonic thickness measurement sensor, an electromagnetic induction thickness gauge, or the like. The detection device may be integrated into the in-line detector.

In some embodiments, the period data table records a correspondence relationship between different service lives of the pipeline, degrees of pipeline wear, and periods (hereinafter referred to as the period) for adjusting the opening degree of the first pressure relief hole.

In some embodiments, the period data table may be determined based on experimental data. For example, technicians may select experimental pipelines with different service lives of the pipeline and different degrees of pipeline wear. A jam (e.g., wax deposition jam, oil sludge jam, or the like) is artificially set in one of the experimental pipelines. Subsequently, a maximum period of reciprocating motion under which the in-line detector is able to break through the jam is tested for different periods of reciprocating motion. The maximum period is determined as the period corresponding to the experimental pipeline in the period data table.

In some embodiments, in the period data table, for a pipeline with a higher service life of the pipeline (e.g., greater than or equal to 10 years) and a higher degree of pipeline wear (e.g., greater than 30%), the processor may set a shorter period (e.g., a period of 1 s to 3 s) to reduce an impact force on an old pipeline wall during a motion process. For a pipeline with a lower service life of the pipeline (e.g., less than or equal to 3 years) and a lower degree of pipeline wear (e.g., less than 10%), the processor may set a longer period (e.g., a period of 5 s to 8 s) to maximize an impact force required for jam breakthrough.

It should be noted that the shorter period may cause high-frequency and low-amplitude axial oscillation in the in-line detector. The longer cycle may cause low-frequency and high-amplitude axial oscillation in the in-line detector.

In some embodiments, the processor may determine the period for adjusting the opening degree of the first pressure relief hole 104 by querying the period data table based on the service life of the pipeline and the degree of pipeline wear.

In some embodiments of the present disclosure, by combining the service life of the pipeline and the degree of pipeline wear, the period for adjusting the opening degree of the first pressure relief hole is determined by querying the period data table. The in-line detector can dynamically match an axial oscillation strategy based on an actual aging degree and operation condition of the pipeline, avoiding secondary damage to the old pipeline caused by single fixed-period oscillation, thereby ensuring jam breakthrough efficiency while considering pipeline safety, and ensuring safety and effectiveness of a jam release process of the in-line detector.

In some embodiments, the processor is configured to: determine a distance set between the plurality of detection arms 2061 and the pipe wall when the plurality of detection arms 2061 are pressed down or relaxed based on the angle variations of the plurality of detection arms 2061 relative to the pipeline axis; generate a three-dimensional deformation data set of the pipeline within the movement mileage based on the distance set and the movement mileage of the in-line detector; and generate pipeline morphological features based on the three-dimensional deformation data set.

Each of the plurality of detection arms 2061 and the pipeline axis form an angle. The plurality of detection arms 2061 and the pipeline axis form a plurality of angles. Every first time interval, each of the plurality of detection arms 2061 and the pipeline axis form an angle variation. The plurality of detection arms 2061 and the pipeline axis form a plurality of angle variations. Over a plurality of first time intervals, each of the plurality of detection arms 2061 and the pipeline axis form a plurality of angle variations, respectively. The plurality of detection arms 2061 and the pipeline axis form a plurality of angle variations, respectively. More descriptions regarding the angle variation may be found in the related descriptions above.

More descriptions regarding the movement mileage may be found in the foregoing content and its related descriptions.

A distance between each of the plurality of detection arms 2061 and the pipeline wall when the plurality of detection arms 2061 are pressed down or relaxed refers to an actual radial distance from an end of the detection arm 2061 hinged on the base to a surface of the inner peripheral wall of the pipeline. The distance between each of the plurality of detection arms 2061 and the pipeline wall when the plurality of detection arms 2061 are pressed down or relaxed may also be represented by an actual radial distance from another end of the detection arm 2061, which abuts against a contact position between the second sealing cup and the pipeline, to the pipeline axis. The two distances are the same. More descriptions regarding the angle variation and the actual radial distance may be found in the related descriptions above.

The distance set refers to a set formed by distances between the plurality of detection arms and the pipeline wall when the plurality of detection arms are pressed down or relaxed. The distance set may include distances between the plurality of detection arms 2061 and the pipeline wall when the plurality of detection arms 2061 are pressed down or relaxed, which are formed over the plurality of first time intervals.

In some embodiments, the processor may determine the actual radial distances based on the angle variations between the plurality of detection arms 2061 and the pipeline axis over the plurality of first time intervals and statistically summarize the actual radial distances to form the distance set. One first time interval corresponds to a distance set of actual radial distances of one pipeline cross-section.

In some embodiments, the three-dimensional deformation data set refers to a data set including a correspondence relationship between the distance set and the movement mileage. The distance set is a data set in a radial direction of the pipeline. The movement mileage corresponding to the distance set is a continuous mileage numerical sequence of the in-line detector in the axial direction of the pipeline.

In some embodiments, the processor may generate the three-dimensional deformation data set in the following way. Within the movement mileage traveled by the in-line detector, the processor may associate and stack the distance set (i.e., actual radial distance data of a plurality of pipeline cross-sections) with a position of the pipeline cross-section in the axial direction of the pipeline of the in-line detector corresponding to the distance set during collection in real time, to ultimately form the three-dimensional deformation data set capable of reflecting cross-sectional shapes of the pipeline at a plurality of positions in the axial direction of the pipeline within the movement mileage.

The pipeline morphological features refer to characteristic data used to reflect a geometric state of the pipeline. For example, the pipeline morphological features may include a pipeline joint, a local pipeline length, or the like.

In some embodiments, the pipeline joint is embodied as a structural feature corresponding to different connection manners, such as a ring-shaped inwardly cured protrusion structure of a hot-melt joint, and a step mutation structure of a socket joint. The local pipeline length is embodied as an axial dimension feature of a specific segment of the pipeline, such as an actual axial length of a certain straight pipe segment.

In some embodiments, the processor may generate the pipeline morphological features based on the three-dimensional deformation data set according to the following way. The processor generates a three-dimensional morphology map of an interior of the pipeline based on the three-dimensional deformation data set (the three-dimensional morphology map may be temporarily saved through the communication mechanism or transmitted to a ground server through the communication mechanism), and extracts local morphology data of continuous pipeline cross-sections in the three-dimensional morphology map, and compares the local morphology data with a preset standard joint morphology template. Merely by way of example, taking a ring-shaped inwardly curved double-peak structure of the hot-melt joint as the standard joint morphology template for an example, a plurality of (e.g., 10) continuous regions in the circumferential direction of the pipeline are selected, a ratio of an actual inner diameter of each region to an inner diameter of the ring-shaped inwardly curved double-peak structure of the hot-melt joint is calculated, and an average value is taken as a matching degree. If the matching degree exceeds a preset threshold, a current point is determined as the pipeline joint. The processor may record movement mileage of the in-line detector corresponding to two adjacent identified pipeline joints, and calculate a mileage difference of the movement mileage, the mileage difference is an actual axial length of a local pipeline between the adjacent pipeline joints, thereby completing generation of the pipeline joint and local pipeline length features. The actual axial length of the local pipeline may serve as a pipe segment length.

In some embodiments of the present disclosure, by generating the three-dimensional deformation data set and the pipeline morphological features, high-precision three-dimensional modeling of internal geometric features of the pipeline can be achieved, and features that are difficult to measure directly, such as the position of the pipeline joint and the actual pipe segment length, can be automatically identified. Problems of difficulty in quantifying an internal geometric state of the pipeline and large errors in manual detection are solved. Meanwhile, core data support is provided for subsequent refined detection, segmented maintenance, and fault location, thereby improving precision and efficiency of detection and maintenance.

In some embodiments, the processor is further configured to: dynamically adjust a rate of change in the opening degree of the first pressure relief hole 104 based on the pipeline morphological features.

The rate of change in the opening degree refers to a variation amplitude of the opening degree of the first pressure relief hole 104.

In some embodiments, when the processor identifies that the in-line detector is about to enter the pipeline joint (e.g., a PE hot-melt joint, where an inwardly curved protrusion is prone to snag debris or the detection arm 2061) ahead based on the pipeline morphological features, the processor may reduce the movement speed of the one or more stoppers 1052, making the rate of change in the opening degree of the opening degree of the first pressure relief hole 104 decrease and an adjustment process smoother, thereby avoiding jolting or impact of the in-line detector caused by an abrupt change in the movement speed of the one or more stoppers 1052.

In some embodiments, the movement speed of the one or more stoppers 1052 is a product of a reference translation speed of the one or more stoppers and a ratio of the movement speed of the in-line detector to the preset reference speed.

More descriptions regarding the movement speed and the preset reference speed may be found in the foregoing content and theits related descriptions.

In some embodiments, when the processor identifies, based on the pipeline morphological features, that the in-line detector has just left the pipeline joint or passed through a sharp bend, the processor may cause the driving mechanism to control the movement speed of the one or more stoppers 1052 to increase, making the rate of change in the opening degree of the opening degree of the first pressure relief hole 104 increase. The first pressure relief hole 104 can quickly recover to a minimum opening degree required to satisfy the driving pressure difference, thereby improving a passing efficiency of the in-line detector.

In some embodiments, the processor may subtract a distance between the in-line detector and the pipeline joint or the sharp bend just passed from the pipeline length to obtain a difference. The processor adds 1 to the difference to obtain a sum and determines a product of a ratio of the sum to the pipeline length and the reference translation speed as the movement speed of the one or more stoppers 1052. More descriptions regarding the pipe segment length may be found in the foregoing content and the its related descriptions.

In some embodiments, the distance between the in-line detector and the pipeline joint or the sharp bend just passed may be obtained through the odometer sensor of the in-line detector.

The reference translation speed refers to a movement speed of the one or more stoppers preset manually according to a design speed of the in-line detector, an inner diameter of the pipeline, and a medium flow velocity. For example, the reference translation speed may be 0.1 m/s, 0.3 m/s, or the like.

In some embodiments, the processor may adjust a data processing period based on the pipeline morphological features.

The data processing period refers to a time interval (also referred to as a sampling frequency) at which a data acquisition card collects pipeline deformation information (e.g., the rate of angle variation). For example, the data processing period may be 2 ms, 5 ms, or the like. More descriptions regarding the data acquisition card may be found in the foregoing content and the its related descriptions.

In some embodiments, the processor may determine a pipeline segment type and an estimated position of the pipeline joint based on the pipeline morphological features. The processor may adjust the data processing period based on the pipeline segment type and the estimated position of the pipeline joint.

Merely by way of example, adjusting the data processing period based on the pipeline segment type is as follows. When the pipeline segment type is a common straight pipe segment, the processor adopts a low-frequency processing period (i.e., the data processing period is relatively large, e.g., the data processing period is 10 ms at this time) to save resources. When the pipeline segment type is identified as the pipeline joint or a known deformation-prone region, the processor adopts a high-frequency processing period (i.e., the data processing period is relatively small, e.g., the data processing cycle is 1 ms at this time) for key monitoring.

Merely by way of example, the processor adjusts the data processing period based on the estimated position of the pipeline joint: the processor predicts an estimated arrival position of a next pipeline joint based on an actual position of a last identified pipeline joint and the pipe segment length. The in-line detector may obtain a real-time movement mileage through the odometer sensor. When the in-line detector leaves the last pipeline joint and travels toward the estimated arrival position, if the in-line detector enters a preset distance range (e.g., 0 m to 5 m) from the estimated arrival position, the processor sends an instruction to the data acquisition card. The data acquisition card temporarily switches the data processing period to the high-frequency processing period (i.e., the data processing period is relatively large, e.g., the data processing period is 1 ms at this time).

In some embodiments of the present disclosure, by dynamically adjusting the rate of change in the opening degree of the first pressure relief hole and the data processing period, adaptive and intelligent segmented management of the operation strategy of the in-line detector is achieved. At the pipeline joint prone to jamming and collision, by smoothly adjusting the opening degree of the first pressure relief hole and switching to the high-frequency processing period, the precision of deformation detection and data completeness are improved. In the common straight pipe segment, resources are saved by the low-frequency processing period. After leaving the pipeline joint or passing the sharp bend, the opening degree is quickly restored to improve the efficiency, so that detection precision, energy consumption, and safety are considered.

The foregoing ideal embodiments according to the present disclosure are provided for inspiration. Based on the foregoing description, relevant personnel can make various changes and modifications without departing from the technical scope of the present disclosure. The technical scope of the present disclosure is not limited to the content of the specification and must be determined based on the scope of the claims.

What is claimed is:

1. An in-line detector for geometric deformation of a non-metallic pipeline with automatic jam release function, comprising: an adaptive module and a detection module, wherein the adaptive module includes a front mandrel, a first cup is disposed on the front mandrel, the first cup is configured to contact and seal an inner peripheral wall of a pipeline to form a first chamber and a second chamber which are separated from each other in a front-and-back direction of the first cup, an auxiliary support mechanism configured to always contact and seal the inner peripheral wall of the pipeline when the pipeline deforms is disposed on the first cup, a first pressure relief hole configured to communicate the first chamber and the second chamber is disposed on the front mandrel, and a control mechanism configured to control an opening degree of the first pressure relief hole and implement speed control is disposed in the first pressure relief hole; and
the detection module includes a base, a power battery and a communication mechanism for connecting to an external device are disposed on the base, a second cup is disposed on the base, a detection mechanism is disposed between the second cup and the base, the communication mechanism is in signal connection to the detection mechanism and the control mechanism, respectively, the power battery is connected to the detection mechanism, the communication mechanism, and the control mechanism, respectively, the second cup is configured to contact the inner peripheral wall of the pipeline to form a third chamber and a fourth chamber which are separated from each other in a front-and-back direction of the second cup, the second chamber and the third chamber are located between the first chamber and the fourth chamber, the second chamber and the third chamber are in communication with each other, a second pressure relief hole configured to communicate the third chamber and the fourth chamber is disposed on the base, a connecting hole is disposed at an end of the base close to the front mandrel, the connecting hole has a frustum shape, a large end of the connecting hole is close to the front mandrel, the connecting hole is disposed along an axial direction of the pipeline, an end of the front mandrel matches the connecting hole, the end of the front mandrel is disposed in the connecting hole, a restoring mechanism is disposed between the end of the front mandrel and the base, and the restoring mechanism is configured to keep the front mandrel connected to the base and assist the end of the front mandrel in inserting into the connecting hole after the end of the front mandrel is disengaged from the connecting hole;
the restoring mechanism includes a first spring, one end of the first spring is fixed on the base, another end of the first spring is fixed on the front mandrel, and the first spring is located in the connecting hole; and
the control mechanism includes a cover plate and one or more stoppers, the cover plate covers an end of the first pressure relief hole located at the first chamber, one or more through holes are disposed in the cover plate, the one or more through holes are configured to communicate the first chamber and the first pressure relief hole, and a driving mechanism configured to drive the one or more stoppers to move and cause the one or more stoppers to block or open the one or more through holes is disposed on the front mandrel.

2. The in-line detector according to claim 1, wherein the first cup includes a first fixed cup, the first fixed cup is annular and fixed on an outer peripheral surface of the front mandrel, a first sealing cup is connected to an outer circle of the first fixed cup, and the first sealing cup has an annular structure.

3. The in-line detector according to claim 2, wherein the auxiliary support mechanism includes a second spring, one end of the second spring is fixed on the first fixed cup, and another end of the second spring is fixed on the first sealing cup.

4. The in-line detector according to claim 3, wherein the one or more through holes include a plurality of through holes, the one or more stoppers include a plurality of stoppers, the plurality of through holes are uniformly distributed along a circumferential direction of the cover plate at intervals, and the plurality of stoppers are arranged corresponding to the plurality of through holes.

5. The in-line detector according to claim 1, wherein the second cup includes a second sealing cup, the second sealing cup has an annular structure, and the second sealing cup is fixed on an outer peripheral surface of the base.

6. The in-line detector according to claim 5, wherein the detection mechanism includes a plurality of detection arms, the plurality of detection arms are uniformly distributed along a circumferential direction of the base, one end of each of the plurality of detection arms is hinged on the base, another end of each of the plurality of detection arms abuts a position where the second sealing cup contacts the pipeline, the second sealing cup is located between the pipeline and the other end of each of the plurality of detection arms, and a third spring is disposed between each of the plurality of detection arms and the base.

7. The in-line detector according to claim 1, wherein an anti-collision head is disposed on the front mandrel, and the anti-collision head is configured to prevent the in-line detector from damaging internal components of the pipeline due to excessive speed or collisions when passing through an elbow.

8. The in-line detector according to claim 7, wherein the anti-collision head is located at a front end of the front mandrel in a displacement direction, and the anti-collision head is made of explosion-proof metal or explosion-proof polyurethane.

9. The in-line detector according to claim 1, further comprising a processor, wherein the processor is disposed on the base of the detection module, and the processor is configured to:
obtain, through the detection mechanism based on a first time interval, an angle variation and a rate of angle variation of a plurality of detection arms relative to a pipeline axis; and
adjust the opening degree of the first pressure relief hole based on the rate of angle variation in advance.

10. The in-line detector according to claim 9, wherein the processor is further configured to:
determine a plurality of deformation quantities of the pipeline based on the angle variation;
determine a deformation rate based on the plurality of deformation quantities;
determine the opening degree of the first pressure relief hole based on the deformation rate;
determine a target occlusion area of each of the one or more through holes by each of the one or more stoppers by querying an opening degree data table based on the opening degree of the first pressure relief hole; and
control, by using the driving mechanism, the one or more stoppers to occlude the one or more through holes based on the target occlusion area.

11. The in-line detector according to claim 9, wherein the processor is further configured to:
obtain a movement speed of the in-line detector every second time interval; and
in response to the movement speed or a movement mileage satisfying a preset condition, control the driving mechanism to drive the one or more stoppers to perform periodic reciprocating motion to periodically adjust the opening degree of the first pressure relief hole.

12. The in-line detector according to claim 11, wherein a period for adjusting the opening degree of the first pressure relief hole is adjusted by querying a period data table based on a service life of the pipeline and a degree of pipeline wear.

13. The in-line detector according to claim 1, further comprising a processor, wherein the processor is disposed on the base of the detection module, and the processor is configured to:
determine a distance set between a plurality of detection arms and a pipe wall when the plurality of detection arms are pressed down or relaxed based on angle variations of the plurality of detection arms relative to a pipeline axis;
generate, based on the distance set and a movement mileage of the in-line detector, a three-dimensional deformation data set of the pipeline within the movement mileage; and
generate pipeline morphological features based on the three-dimensional deformation data set.

14. The in-line detector according to claim 13, wherein the processor is further configured to:
dynamically adjust a rate of change in the opening degree of the first pressure relief hole based on the pipeline morphological features.
